(19) United States
(12) Patent Application Publication
(10) Pub. No.: US 2007/0239820 A1
(43) Pub. Date: Oct. 11, 2007

(54) SYSTEM AND METHOD FOR PROVIDING QUALITY FEEDBACK METRICS FOR DATA TRANSMISSION IN RICH MEDIA SERVICES

(75) Inventors: Daidi Zhong, Tampere (FI); Vidya Setlur, Cupertino, CA (US); Miska Hannuksela, Ruutanan (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/562,927

(22) Filed: Nov. 22, 2006

Related U.S. Application Data
(60) Provisional application No. 60/739,521, filed on Nov. 23, 2005.
(60) Provisional application No. 60/855,684, filed on Oct. 31, 2006.

(51) Int. Cl. G06F 15/16

(52) U.S. Cl. 709/201

(57) ABSTRACT

An improved system and method for providing quality feedback metrics for data transmission in rich media services. Extensions are provided to quality measures concerning the transmission of rich media content to the client. Such measures are defined as new extensions in the PSS Base Vocabulary, PSS Quality of Experience and RTP/AVPF. With the rich media client utilizing such measures, the server can assess the quality of the transmission and consider error recovery mechanisms, such as packet retransmission, to provide the client with the missing information.

### FIELD OF THE INVENTION

The present invention relates generally to the transmission of rich media content. More particularly, the present invention relates to providing of quality metrics during data transmission in rich media applications.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Rich media content is referred to dynamic, interactive content that is graphically rich and contains compound or multiple media, including graphics, text, video and audio, delivered through a single interface. Scalable Video Graphics (SVG) is the main container for rich media presentations. Until recently, applications for mobile devices were text-based with limited interactivity. However, as more wireless devices are coming equipped with color displays and more advanced graphics rendering libraries, consumers are demanding a richer experience from their wireless applications. A real time, rich media content streaming service is imperative for mobile terminals, especially in the area of Multimedia Broadcast Multicast Service (MBMS), Packet-switched Streaming Service (PSS), and (Multimedia Messaging System (MMS) services.

SVG is designed to describe resolution-independent two dimensional vector graphics and often embeds other media such as raster graphics, audio, and video. SVG allows for interactivity using the event model and animation concepts borrowed from the Synchronized Multimedia Integration Language (SMIL). SVG also allows for infinite zoomability and enhances the power of user interfaces on mobile devices. As a result, SVG is gaining importance and becoming one of the core elements of multimedia presentation, especially for rich media services such as mobile TV, live updates of traffic information, weather, news, etc. SVG is XML-based, allowing more transparent integration with other existing web technologies. Mobile Scalable Vector Graphics (Mobile SVG) has been adopted as the new imaging standard by the Third Generation Partnership Project (3GPP) for playing a pivotal role in bringing improved graphics and images to mobile devices. Recently, 3GPP and the Open Mobile Alliance (OMA) have begun work on rich media based activities.

The concept of scene and scene updates are used in rich media applications. The “scene” describes the spatial organization of scene elements, the temporal organization of scene elements, synchronization information, and interaction among the SVG elements. A scene is typically first sent to the client to initialize the presentation layout. The scene is a self-contained SVG document within <svg></svg> tags, where the animations and elements can be grouped together using the <g>element. It may also contain element definitions enclosed in the <defs></defs> block that can either be used in the current scene or by elements in subsequent scene updates. Scene updates are incremental updates to the SVG document object model (DOM) that get sent to the client device one at a time. These updates include SVG element addition, element deletion, element replacement and element attribute update operations.

Although there exist some quality metrics for media such as audio and video concerning packet loss, transmission quality and media repair information, there are currently no quality metrics for SVG-based scene and scene updates in a rich media application. During a rich media application, a client can often report the quality of transmission and presentation to the server. Such information is quite useful for the server to make optimal decisions about adjusting the transport system. Currently, higher-layer frameworks such as PSS and MBMS have been widely used in multimedia applications to address this issue. Solutions include defining syntaxes to represent the necessary feedback data for this purpose, and subsequently mapping these syntaxes to lower-layer protocols, such as real time transport protocol (RTCP). However, these solutions mainly concentrate on continuous data, such as audio, video, and timed text, and do not cater specifically to rich media applications containing SVG, discrete and continuous media. As the demand of deploying rich media applications is consistently increasing, it is important to define extensions to the present framework, allowing clients to send quality-related feedback data back to server.

As discussed above, there are currently a number of only preliminary and partial solutions for local interactivity (i.e. strictly client-side) and rudimentary remote interaction such as HTTP GET/POST in an SVG-like rich media presentation. Real-time media streams that use Real-Time Transport Protocol (RTP) are, to a certain degree, resilient against packet losses. The RTP control protocol (RTCP) can be used to monitor the quality of service and to convey information about the participants in an on-going RTP session. It is based on the periodic transmission of control packets to all participants in the session, using the same distribution mechanism as that of the data packets. The RTP control protocol performs four functions. First, the primary function is to provide feedback on the quality of the data distribution. The second function is to carry a persistent transport-level identifier for an RTP source called the canonical name or CNAME. The third function is to control the rate of sending packets, in order for RTP to scale up to a large number of participants. Lastly, the fourth function, which is optional, is to convey minimal session control information.

RTP/AVPF is an extension based on RTCP to enable receivers to provide, statistically, more immediate feedback to the senders and therefore allow for short-term adaptation and efficient feedback-based repair mechanisms to be implemented. This early feedback profile (AVPF) maintains the AVP bandwidth constraints for RTCP and preserves scalability to large groups. A number of new SDP parameters are defined in this profile to describe a session. Correspondingly, formats of RTCP feedback messages are also defined and can be divided into three categories: (1) transport layer feedback messages; (2) payload-specific feedback messages; and (3) application layer feedback messages. Unfortunately, most of the message formats proposed for RTP/AVPF are dedicated for audio-video applications and are not suitable for rich media applications.

The PSS base vocabulary contains four components called “PssCommon”, “Streaming”, “ThreeGPFileFormat” and “PssSmil”. The division of the vocabulary into these components is motivated by the fact that the PSS contains three different base applications: (1) pure RTSP/RTP-based streaming, as described by the streaming component; (2) 3GP file downloading or progressive downloading, as described by the ThreeGPFileFormat component; and (3) the SMIL presentation, as described by the PssSmil component. The SMIL presentation can include downloadable images, text, etc., as well as RTSP/RTP streaming and downloadable 3GP files. Capabilities that are common to all PSS applications are described by the PssCommon component. The three base applications are distinguished from each other by the source of synchronization. For pure streaming, the source is RTP. For 3GP files, the source is inherit in the 3GP file format. For SMIL presentations, timing is provided by the SMIL file. The PSS-specific components contain a number of attributes expressing capabilities. However, one attribute is missing, which describes the capability of client to provide feedback.

For users, operators and Internet service providers, end-to-end quality of service is highly important. Quality of Experience (QoE) encompasses a wide range of services, including wider bandwidth for audio and speech, new multimedia services such as Internet Protocol Television (IPTV) and statistical data of lost and corrupted packets of content. Both incumbent and emerging service providers are under pressure to increase their operating results by gaining market share, expanding services while reducing costs, and creating customer loyalty. One such approach in minimizing customer turnover is QoE delivery. QoE metrics can help enhance this continuity and the synchronization of such continuous media, including dynamic and interactive media scenes (DIMS) content, for example.

The 3GPP QoE metrics have been specified in PSS systems as an optional feature for both the PSS streaming server and client and do not disturb the PSS service. A PSS client supporting the feature performs the quality measurements in accordance with the measurement definitions, aggregates them into client QoE metrics, and reports the metrics to the PSS server using the content reception reporting procedure. However, all of the metrics defined in PSS are only applicable to at least one of audio, video, speech and timed text media types and are not applicable to other media types such as synthetic audio, still images, bitmap graphics, vector graphics, and text. Any unknown metric is ignored by the client and is not included in any QoE report.

MBMS QoE metrics are optional for both MBMS streaming servers and MBMS without disturbing the MBMS service. A MBMS client supporting MBMS QoE metrics typically performs the quality measurements in accordance with the measurement definitions, aggregates them into client QoE metrics, and report the metrics to the MBMS server using the content reception reporting procedure.

U.S. patent application Publication No. 2005/0249117 describes a method for transmitting data flows having different quality of service (QoS) attributes over a network link structured in two or more channels. This method classifies arriving packets to determine their required/assigned QOS attributes and places the classified packets into one of several logical channel queues, with the selected logical channel queue having an appropriate corresponding set of QoS attributes defined. A radio link controller examines the available channels and, for each channel, selects a logical channel queue whose contents will be transmitted thereon. The selection of the logical channel queue is performed in accordance with the set of QoS attributes. Therefore, each flow can have different QoS characteristics including priorities, reliabilities (ARQ, no ARQ, etc.). However, this system focuses mainly on the assignment of QoS attributes to different logical queues, and does not address the QoS parameters themselves, particularly for rich media applications.

U.S. patent application Publication No. 2005/0169171 describes a system for supporting end-to-end Quality of Service (QoS) control. A QoS profile identifier is generated that maps to a QoS parameter. The identifier is transmitted over the radio communication system to an end station, and the end station determines the QoS parameter based on the received identifier. However, this system concerns the control of the QoS parameters rather than the actual data sent as QoS metrics. Furthermore, with this system, it is necessary to define particular information for QoS metric in an end-to-end rich media application.

### SUMMARY OF THE INVENTION

The present invention describes a system and method for providing quality metrics during data transmission in rich media applications. There are several use cases for interactive rich media services that such quality metrics can play an important role. For example, interactive Mobile TV services involve the providing of a deterministic rendering and behavior of rich-media content including audio-video content, text, graphics, images, along with TV and radio channels, together in the end-user interface. The service must provide convenient navigation thru content in a single application or service and must allow for synchronized interaction in local or in distant activities, such as voting and personalization (e.g.: related menu or sub-menu, advertising and content in function of the end-user profile or service subscription). In this service, quality metrics describing the nature of the data transmission in terms of packets lost and corrupted are useful to the service as feedback.

A live chat service can be incorporated within a web cam or video channel, or in a rich-media blog service. End-users can register, save their surname and exchange messages. Messages appear dynamically in the live chat service along with rich-media data provided by the end-user. The chat service can be either private or public in one or more multiple channels at the same time. End-users are dynamically alerted of new messages from other users. Dynamic updates of messages within the service occur without reloading a complete page. Quality metrics describing which of these updates are incorrectly received can help in error recovery and concealment to improve the overall user experience of the service.

In addition, video/song selection services, allow users to select/request a song or movie of their choice in real time from the server. The content update may depend on which client sent out the request earlier, or it may be based on the priority assigned to each client. Again in this situation, QoS metrics can be used to assess if the requested song content arrived properly or not to the client.

The Remote user interface (UI) is a mechanism that enables user interfaces to be rendered on other devices than those that run the application logic. Manufacturers are creating devices that are highly optimized for certain environments. As the devices are intended for a diverse range of purposes, their UI capabilities can vary considerably; screen size and ratio, color depth, windowing system with various component sets, and input methods are making the environment highly heterogeneous. At the same time, application developers and UI designers are trying to create user interfaces that are highly optimized for the rendering platform so that the user experience is improved by having the respective application easy to learn and use. When such a remote UI is rendered on another device than the one that is running the application logic, provisions need to be made so that the user can perceive the UI as a local application making it intuitively usable. QoS metrics are useful in this case to assess if all the UI content is correctly streamed remotely to another client or not.

Among all the above cases, the applications can be either broadcast-oriented or PtP-oriented. According to the present invention, various quality metrics can be defined for conveying information, such as extensions to the PSS Base Vocabulary, extensions to the PSS Quality of Experience (QoE)—RTP packet loss, lists of active SVG elements incorrectly received, lists of SVG elements correctly received and decoded, corruption duration, corrupted SVG groups, extensions to RTP/AVPF and extensions to transport layer feedback messages. With the rich media client utilizing such measures, the server can assess the quality of the transmission and consider error recovery mechanisms such as packet retransmission to provide the client with the missing information.

Various embodiments of the present invention also provide QoE metrics that can be used for statistical data analysis, as well as for error recovery and error concealment, of DIMS-specific content and services. Such metrics can be used to report, for example, the number of RTP packets lost for each priority during a specific period, corrupted scenes, corrupted scene updates, and DIMS corruption duration values (measured by the time duration of corrupted scenes and scene updates.)

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2;

FIG. 4 is a depiction of a RTCP message used for reporting the loss of packets for each priority level of information during one specific period;

FIG. 5 is a depiction of a RTCP message used for reporting how many elements, which are among the most recent ‘list of active elements’, have not been correctly received and decoded;

FIG. 6 is a depiction of a RTCP message used for reporting which elements are correct received, decoded and active in a current group;

FIG. 7 is a depiction of a RTCP message used for indicating the corruption duration during one group of packets; and

FIG. 8 is a depiction of a RTCP message used for indicating groups which have been corrupted due to the loss of packets of the Scene data for the respective groups.

### DETAILED DESCRIPTION OF THE PREFERRED EMBODIMENTS

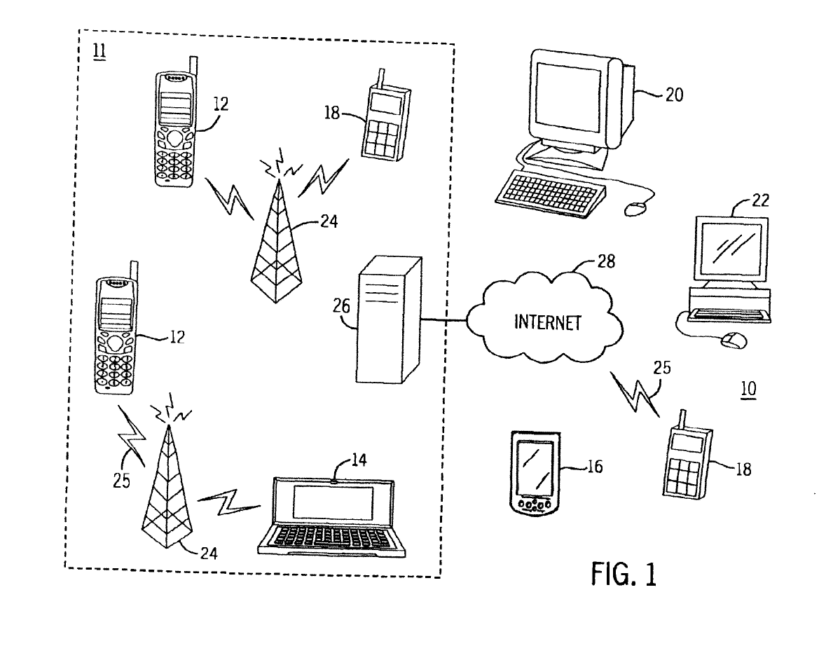

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, one or more ad-hoc networks between communication devices, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types. The communication devices may communicate directly between each other.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

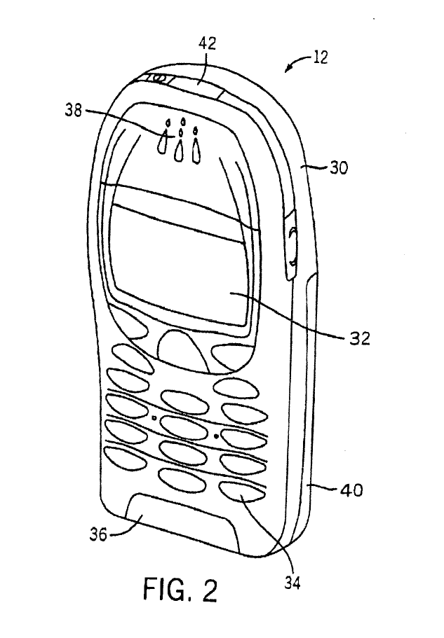

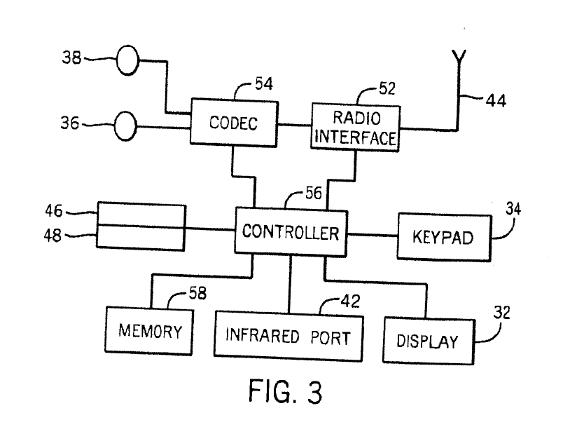

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention describes a system and method for providing quality metrics during data transmission in rich media applications. The following description provides details concerning quality measures. The new extensions discussed herein are defined in the PSS Base Vocabulary, PSS Quality of Experience and RTP/AVPF. In order to provide QoE information dedicated to rich media applications, it is necessary to define some extensions in PSS. Correspondingly, some extensions are also defined in the lower-layer protocol RTP/AVPF, which provide practical feedback services for the extended QoE data. PSS and RTP/AVPF are closely related to each other. The extended data transported in RTP/AVPF is derived from the extended content in PSS.

Extension to the PSS Base Vocabulary. The PSS base vocabulary contains four components called “PssCommon”, “Streaming”, “ThreeGPFileFormat” and “PssSmil”. As discussed previously, the division of the vocabulary into these components is motivated by the fact that the PSS contains three different base applications:. (1) pure RTSP/RTP-based streaming, as described by the streaming component; (2) 3GP file downloading or progressive downloading, as described by the ThreeGPFileFormat component; and (3) the SMIL presentation, as described by the PssSmil component. In order to describe the capability and mode of the feedback provided by the client, a new attribute ‘FeedbackMethod’ is added to PssCommon Component according to one embodiment of the present invention. The nature of the attribute is as follows:
Attribute name: FeedbackMethod
Attribute definition: This attribute describes capability and mode of the feedback provided by the client.
Component: PssCommon
Type: Literal
Legal values: “None”, “SMS”, “MMS”, “HTTP”, “RTSP”
Resolution rule: Append

### EXAMPLE

### <FeedbackMethod>MMS</FeedbackMethod>

Extensions to the PSS Quality of Experience. The PSS Quality of Experience metrics feature is optional for both PSS servers and clients, and does not disturb the PSS service. A PSS server that supports the QoE metrics feature signals the activation and gathering of client QoE metrics when desired. A 3GPP PSS client supporting the feature performs the quality measurements in accordance with the measurement definitions, aggregates them into client QoE metrics, and reports the metrics to the PSS server using the QoE transport protocol when so requested. A PSS client measures the metrics at the transport layer, but may also measure the metrics at the application layer for improved accuracy. In order to describe the current situation (correctly received, incorrectly received or lost) of the samples and elements in client, a number of new metrics are defined.

For reporting the number of RTP packets lost for each priority during a specific period, the syntax, according to one embodiment of the present invention, is Lost_Priority={1F,3E,0,21};Range:Seq_Num=60000-60500. For the RTP packets whose sequence numbers are ranging from 60000 to 60500, the packet loss is as follows (with the number of lost packets being expressed in hex format):
1F Priority=0 packets lost
3E Priority=1 packets lost
zero Priority=2 packets lost
21 Priority=3 packets lost

It should be noted that the locations and corresponding values of the “Lost_Priority=. . . ” and “Range:Seq_Num=. . . ” may be altered in other embodiments of the present invention. Additionally, the sequential order of the four elements within the Lost_Priority field may be altered.

For reporting the list of elements among the most recent ‘list of active elements’ that have not been correctly received and decoded, the ‘list of active elements’ is sent once per group. In response to the ‘list of active elements’, the Lost_Element defined below can be sent multiple times in any time during or after the transmission process of this group. The syntax for this reporting, according to one embodiment of the invention, is Lost_Element={element10,element22, element 45};Range:GRP=12. In the group with GRP=12, three active elements have been lost. They are element10, element22 and element45. It should also be noted that, in other embodiments of the present invention, the locations and corresponding values of the “Lost_Element=. . . ” and “Range:GRP=. . . ” fields may be altered.

For reporting which elements are correctly received, decoded and active in current group, regardless of whether the ‘list of active element’ has been received by client, the client may send the list defined below to describe current situation of active elements in client. The syntax for this reporting, according to one embodiment of the present invention, is Active_Element={element1,element2, element 4, element5, element8, element11};Range:GRP=13. In this particular instance, the current group has a GRP=13. Six active elements have been correctly received within this group. They are element10, element22 and element 45. It should be noted that the locations and corresponding values of the “Active_Element=. . . ” and “Range:GRP=. . . ” fields may be altered in various embodiments of the present invention.

For reporting the Corruption Duration that is measured by the count of corrupted scene update, the syntax in one embodiment is Corruption_Duration_Sceneupdate={30 12345; 75 12555};Range:GRP=16. Among the RTP packets for the group with GRP=16, there are a total of two corruptions caused by lost of the packet for Scene Update. If one of the packets for a specific Scene Update is lost and has not been usefully repaired, this Scene Update is regarded as lost. The sequence number of the first packet of the first lost scene update is 12345. This Scene Update lasted for 30 packets. The sequence number of the first packet of the second lost Scene Update is 12555. This Scene Update lasted for 75 packets. The server decides whether to send the remaining Scene Updates based on the above information. In another example, where

Corruption_Duration_Sceneupdate={30 12345;?12555};Range: GRP=16, the sequence number of the first packet of the first lost scene update is 12345. This Scene update lasted for 30 packets. The sequence number of the first packet of the second lost scene update is 12555. If the exact duration is unknown, a ‘?’ is inserted.

For reporting corrupted groups, the syntax in one embodiment is Corrupted_Group={14}. In this example, the group with GRP=14 is corrupted, due to the loss of packet of the Scene data of this group. The server may choose to not send any further packets related to these groups. It should also be noted that the locations and corresponding values of the “Corruption_Duration_Sceneupdate=. . . ” and “Range: GRP=. . . ” fields may be altered in alternative embodiments of the present invention.

Deducing the boundary between consecutive groups in a scene is important in order to know to which group the missing packets actually belong. For this purpose, the S and M flags defined in the RTP payload header for SVG data may be used. The S flag (1 bit) indicates whether the current packet contains the starting point of the current sample, while the M flag indicates the ending point of a current sample. The combination of the M and S flags provide the following information:

When M=1, S=1, the current packet contains a complete sample.

When M=0, S=1, the current packet contains the first fragment of a sample.

When M=1, S=0, the current packet contains the final fragment of a sample.

When M=0, S=0, the current packet contains a middle fragment of a sample.

In this case, a “sample” refers to an SVG scene, scene update, SVG similarity information or an active list of SVG elements.

Extensions to RTP/AVPF. In the internet-draft of Extended RTP Profile for RTCP-based Feedback (RTP/AVPF), which can be found at www.ietforg/internet-drafts/draft-ietf-avt-rtcp-feedback-11.txt, a new payload format-specific SDP attribute is defined as an SDP media attribute to indicate the capability of using RTCP feedback as specified in that document: “a=rtcp-fb”. Correspondingly, two extensions on the RTCP packet are also defined in order to transmit feedback messages (Transport-layer/Payload-layer/Application-layer). The above syntaxes, which are defined in PSS QoE, are mapped into this SDP+RTCP profile. This can be used as an extension of the RTP/AVPF to provide feedback message for rich media interactions.

The syntax of the “rtcp-fb” attribute is as follows (the feedback types and optional parameters are all case sensitive). The parameters that are underlined are newly defined according to the present invention:

| | |
|---|---|
| rtcp-fb-syntax | = “a=rtcp-fb:” rtcp-fb-pt SP rtcp-fb-val CRLF |
| rtcp-fb-pt | = “*” ; wildcard: applies to all formats |
| | / fmt ; as defined in SDP spec |
| rtcp-fb-val | = “ack” rtcp-fb-ack-param |
| | / “nack” rtcp-fb-nack-param |
| | / “trr-int” SP 1*DIGIT |
| | / rtcp-fb-id rtcp-fb-param |
| rtcp-fb-id | = 1*(alpha-numeric / “−” / “_”) |
| rtcp-fb-param | = SP “app” [SP byte-string] |
| | / SP token [SP byte-string] |
| | / ; empty |
| rtcp-fb-ack-param | = SP “rpsi” |
| | / SP “app” [SP byte-string] |
| | / SP “aei” |
| | / SP token [SP byte-string] |
| | / ; empty |
| rtcp-fb-nack-param | = SP “pli” |
| | / SP “sli” |
| | / SP “rpsi” |
| | / SP “lppi” |
| | / SP “lei” |
| | / SP “cdsu” |
| | / SP “cg” |
| | / SP “app” [SP byte-string] |
| | / SP token [SP byte-string] |
| | / ; empty |

In the above “rtcp-fb” attribute syntax, one extension is added to ACK (positive response) and four extensions added to NACK (negative response). The following parameters are defined for use with “ack and “nack.” “aei” denotes an Active Elements Indication. “lppi” denotes a Lost Priority Packets Indication. “lei” denotes a Lost Elements Indication. “cdsu” denotes a Corruption Duration Counted by Scene Update. “cg” denotes a Corrupted Group. Corresponding to these SDP parameters, the new feedback messages are defined as follows based on RTP/AVPF.

Extension to Transport Layer Feedback Messages: Transport layer feedback messages are identified by the value PT=RTPFB for the Payload Type (PT) field in the RTCP header, where the PT field indicates whether the packet belongs to the transport layer, payload layer or application layer. A single general-purpose transport layer feedback message so far defined in RTP/AVPF is generic NACK. It is identified by means of the FMT parameter as follows:

0: unassigned

1: Generic NACK

2-30: unassigned

31: reserved for future expansion of the identifier number space

An ‘lppi’ NACK message is defined in the transport layer and is defined below to provide the indication of lost packets for each priority. Such a NACK message is identified by PT=RTPFB and FMT=30.

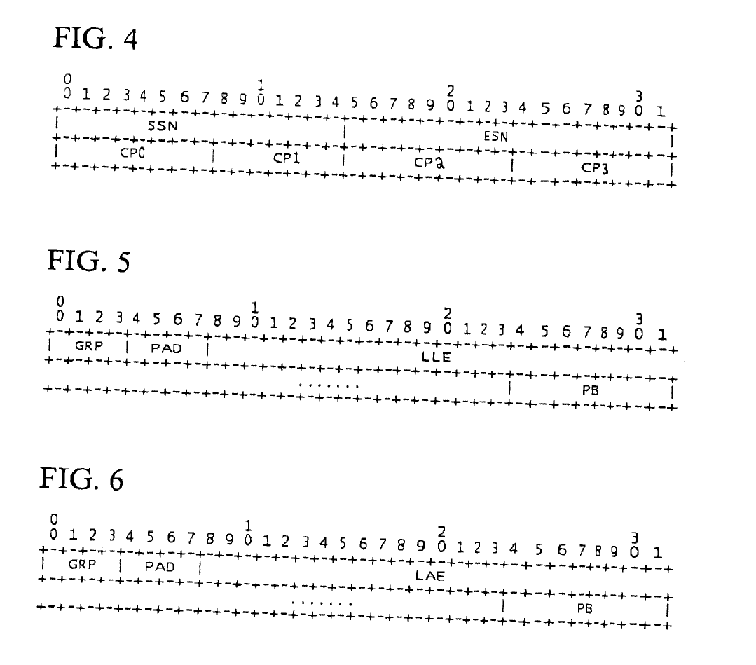

For a Lost Priority Packets Indication (rtcp-fb-param=lppi), SVG RTP packets are divided into four priorities. The priority level is indicated by the GRP filed in the RTP header. The RTCP message reports the loss of packets for each priority during one specific period. The format for the lost priority packets indication is depicted in FIG. 4. The SSN, which is 16 bits, represents the sequence number of the starting point for the current measurement. The ESN, which is also 16 bits, represents the sequence number of the ending point for the current measurement. CP0, CP1, CP2 and CP3 are each 4 bits in length. CP0 represents the number of lost packets with priority 0. CP1 represents the number of lost packets with priority 1. CP2 represents the number of lost packets with priority 2. CP3 represents the number of lost packets with priority 3.

Extensions to payload layer feedback messages: Payload layer feedback messages are identified by the value PT=PSFB for the Payload Type (PT) field in the RTCP header. Three payload-specific feedback messages are currently defined in RTP/AVPF, in addition to an application layer feedback message. These messages are identified by means of the FMT parameter as follows:

0: unassigned

1: Picture Loss Indication (PLI)

2: Slice Lost Indication (SLI)

3: Reference Picture Selection Indication (RPSI)

4-14: unassigned

15: Application layer feedback message

16-30: unassigned

31: reserved for future expansion of the sequence number space

The following discuses the definition of four new FCI formats for the payload-specific feedback messages. In each of the formats, the SVG group (GRP) filed is present so that several RTCP/AVPF packets belonging to the same group contain the same GRP id in their underlying formats. Such packets together represent the entire information for that particular group (GRP).

Lost Elements Indication (rtcp-fb-param=lei), FMT=27: The SVG presentation contains many elements which are valid only within current group. The ‘list of active elements’ is sent to client once per group. The RTCP message depicted in FIG. 5 reports how many elements, which are among the most recent ‘list of active element’, have not been correctly received and decoded. The GRP field is 4 bits and indicates the group number about which the current packet is reporting. The PAD field is 4 bits and indicates the length of the padding bits at the end of this packet, which is counted based on BYTE. The LLE field is variable and represents the text-based list of the lost elements, separated by commas or semicolons, for example “element1, element3, element5, element6” or “element1;element3; element5; element6.” The PB field is also variable and indicates the padding bits counted based on BYTE. The length is indicated by PAD. The PB makes the whole packet 32-bits aligned.

Active Elements Indication (rtcp-fb-param=aei), FMT=28: The RTCP message defined in FIG. 6 reports which elements are correctly received, decoded and active in current group. The GRP field is 4 bits and indicates the group number about which the current packet is reporting. The PAD field is 4 bits and indicates the length of the padding bits at the end of this packet, which is counted based on BYTE. The LAE field is variable and represents the text-based list of the lost elements, separated by commas, for example “element1, element3, element5, element6”. The PB field is also variable and represents the padding bits counted based on BYTE. The length is indicated by PAD. The PB field makes the whole packet 32-bits aligned.

Corruption Duration counted by Scene Update (rtcp-fb-param=cdsu), FMT=29:

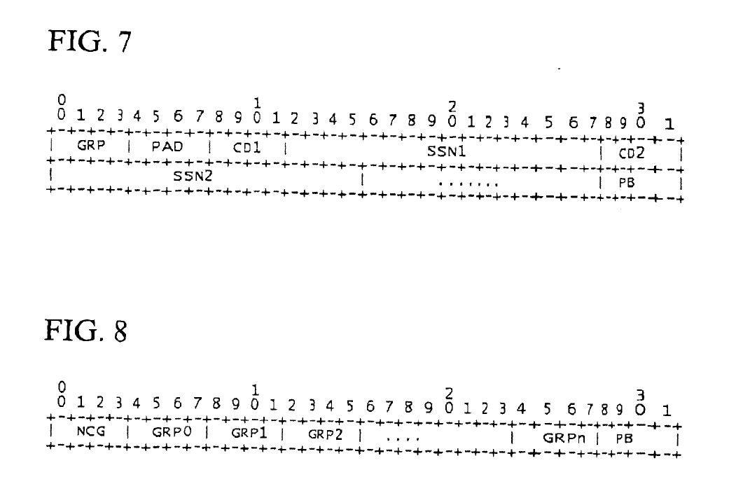

The RTCP message defined in FIG. 7 indicates the corruption duration during one group. Each corruption starts from one specific RTP packet and lasts for several packets. The GRP field is 4 bits and indicates the group number about which the current packet is reporting. The PAD field is 4 bits and indicates the length of the padding bits at the end of this packet. The CDn field is also 4 bits and represents the corruption duration of one specific list packet in the current group. The SSNn field is 16 bits and indicates the sequence number of the corresponding scene update that contains at least one lost packet. Such lost packets cannot be repaired. The (CD, SSN) pairs are listed in increasing order indexed by sequence numbers. The PB field is variable and indicates padding bits counted based on 4-bits. The length is indicated by PAD. The PB makes the whole packet 32-bits aligned.

Corrupted Group (rtcp-fb-param=cg), FMT=30: The RTCP message depicted in FIG. 8 indicates the corrupted groups, due to the loss of packet of the Scene data of these groups. The NCG field is 4 bits and represents the number of the groups about which the current packet is reporting. The GRPn is also 4 bits and represents the GRP of the group that has been corrupted. They are placed one by one. The total number is indicated by the NCG field. The PB field is variable and represents the padding bits. The length can be deduced from NCG. The PB field makes the whole packet 32-bits aligned.

Various embodiments of the invention also involve using PSS and MBMS-based QoS metrics as a basis to introduce QoE metrics that can be used for statistical data analysis of DIMS-specific content and services. Such metrics can be used to report, for example, the number of RTP packets lost for each priority during a specific period, corrupted scenes, corrupted scene updates, and DIMS corruption duration values (measured by the time duration of corrupted scenes and scene updates.) Each of these is discussed below. The DIMS QoE metrics are an optional feature for both the DIMS streaming server and client, without disturbing the DIMS service itself. A DIMS client supporting this feature can perform the quality measurements in accordance to the measurement definitions, aggregate them into client QoE metrics and report the metrics to the DIMS server using the content reception reporting procedure. The DIMS based-QoE metrics rely on current 3GPP frameworks used to transmit the QoE information to the server from the client. Such 3GPP frameworks include the use of RTSP for Unicast services in PSS and the use of HTTP with an XML object for multicast services in MBMS.

The number of RTP packets lost for each priority during a specific period can be reported in accordance with the following. While a break in RTP sequence numbers indicates a missing packet, a boolean priority indicates whether the importance of the missing packet is low (P=0) or high (P=1). The syntax for this reporting is
Lost_Priority={X, Y}; Range:=Sy−Sz

For semantics if the above syntax, for RTP packets whose sequence numbers range from Sy to Sz, there are, in total, X low priority packets lost and Y high priority packets lost. In an alternative embodiment, variants of the priority values may be used.

For reporting corrupted scenes, a DIMS scene is identified as corrupted if the client is unable to construct a valid DOM structure from the scene content. The syntax for reporting corrupted scenes is:
Corrupted_Scenes={S2 Na, S7 Nb}

In terms of semantics for the above syntax, a scene with a sequence number S2 lasting Na packets, and a scene with sequence number S7 lasting Nb packets, are corrupted.

For reporting corrupted scene updates, a DIMS scene update is identified to be corrupted if the client is unable to construct a valid DOM structure after the update is applied to the current DOM structure on the client. The syntax for the reporting of corrupted scene updates is:
Corrupted_SceneUpdates={S5 Nc, S22 Nd}

In terms of semantics for the above syntax, a scene update with sequence number S5 lasting Nc packets, and a scene update with sequence number S22 lasting Nd packets, are corrupted.

In another embodiment of the present invention, the metrics for both corrupted scenes and corrupted scene updates can be combined into a single common metric for the DIMS media type.

In addition to the above, a DIMS corruption duration value can also be reported. This value is measured by the time duration of corrupted scenes and scene updates. The syntax for reporting this value is:
DIMS_Corruption_Duration={S3Ta; S22Tb}

In this example, there are two corruption sets. The sequence number of the first packet in the first corruption set is S3, with a time duration Ta. The sequence number of the first packet of the second corruption set is S22, with a time duration Tb. It should be noted that each corruption set may contain a combination of corrupted scenes and scene updates.

In another example, DIMS_Corruption Duration={S3 Ta; S22?}; Range:=Sy−Sz. In this example, the sequence number of the first packet of the first corruption set is S3, with a time duration Ta. The sequence number of the first packet of the second corruption set is S22. If the exact time duration is unknown, a ‘?’ is inserted. The “?” designation can be used in conjunction with other metrics as well. Additionally, it should be noted that, rather than using time duration, sequence numbers can be used to indicate a corruption duration in one particular embodiment of the present invention.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing quality feedback metrics for data transmission in rich media services, comprising:
receiving rich media content from a remote device; and
in response to the receipt of the rich media content, transmitting quality of service information to the remote device, the quality of service information including at least one quality of service metric extension describing quality characteristics of the received rich media content.

2. The method of claim 1, wherein the at least one quality of service metric extension includes at least one extension in the packet-switched streaming service vocabulary.

3. The method of claim 2, wherein the at least one extension in the packet-switched streaming service vocabulary includes a “FeedbackMethod” component describing the capability and mode of provided feedback.

4. The method of claim 1, wherein the at least one quality of service metric extension includes at least one extension for packet-switched streaming service quality of experience metrics.

5. The method of claim 4, wherein the at least one extension for packet-switched streaming service quality of experience metrics includes syntax for reporting the number of RTP packets lost for each priority during a specific period of received rich media content.

6. The method of claim 4, wherein the at least one extension for packet-switched streaming service quality of experience metrics includes syntax for reporting a list of elements among the most recent list of active elements that have not been correctly received and decoded.

7. The method of claim 4, wherein the at least one extension for packet-switched streaming service quality of experience metrics includes syntax for reporting which elements are correctly received, decoded and active in a current group of received rich media content.

8. The method of claim 4, wherein the at least one extension for packet-switched streaming service quality of experience metrics includes syntax for reporting a Corruption_Duration that is measured by a count of corrupted scene updates.

9. The method of claim 4, wherein the at least one extension for packet-switched streaming service quality of experience metrics includes syntax for deducing a boundary between groups in a scene of received rich media content.

10. The method of claim 1, wherein the at least one quality of service metric extension includes at least one extension in the extended real time transport protocol profile for RTCP-based feedback.

11. The method of claim 10, wherein the at least one extension in the extended real time transport protocol profile for RTCP-based feedback includes an indication of a loss of packets for each priority during one specific period of received rich media content.

12. The method of claim 10, wherein the at least one extension in the extended real time transport protocol profile for RTCP-based feedback includes an indication of how many elements which are among the most recent list of active elements have not been correctly received and decoded.

13. The method of claim 10, wherein the at least one extension in the extended real time transport protocol profile for RTCP-based feedback includes an indication elements that have been correctly received, decoded and active in a current group of received data.

14. The method of claim 10, wherein the at least one extension in the extended real time transport protocol profile for RTCP-based feedback includes an indication of corruption duration during one group of received data.

15. The method of claim 10, wherein the at least one extension in the extended real time transport protocol profile for RTCP-based feedback includes an indication of corrupted groups due to the loss of packets of received scene data.

16. The method of claim 1, wherein the rich media content comprises dynamic and interactive media scenes (DIMS)-specific content.

17. The method of claim 16, wherein the at least one quality of service metric extension describes a number of Real-Time Transport Protocol (RTP) packets lost for each priority of the received rich media content during a specific period.

18. The method of claim 16, wherein the at least one quality of service metric extension describes DIMS scenes received from the remote device which have been corrupted.

19. The method of claim 16, wherein the at least one quality of service metric extension describes DIMS scene updates received from the remote device which have been corrupted.

20. The method of claim 16, wherein the at least one quality of service metric extension describes both corrupted DIMS scenes and corrupted DIMS scene updates received from the remote device.

21. The method of claim 16, wherein the at least one quality of service metric extension describes a duration of corrupted DIMS scenes and scene updates received from the remote device.

22. A computer program product, embodied in a computer-readable medium, for providing quality feedback metrics for data transmission in rich media services, comprising:
computer code for receiving rich media content from a remote device; and
computer code for, in response to the receipt of the rich media content, transmitting quality of service information to the remote device, the quality of service information including at least one quality of service metric extension describing quality characteristics of the received rich media content.

23. An electronic device, comprising:
a processor; and
a memory communicatively connected to the processor and including:
computer code for receiving rich media content from a remote device; and
computer code for, in response to the receipt of the rich media content, transmitting quality of service information to the remote device, the quality of service information including at least one quality of service metric extension describing quality characteristics of the received rich media content.

24. The electronic device of claim 23, wherein the at least one quality of service metric extension includes at least one extension in the packet-switched streaming service vocabulary.

25. The electronic device of claim 24, wherein the at least one extension in the packet-switched streaming service vocabulary includes a “FeedbackMethod” component describing the capability and mode of provided feedback.

26. The electronic device of claim 23, wherein the at least one quality of service metric extension includes at least one extension for packet-switched streaming service quality of experience metrics.

27. The electronic device of claim 26, wherein the at least one extension for packet-switched streaming service quality of experience metrics includes syntax for reporting the number of RTP packets lost for each priority during a specific period of received rich media content.

28. The electronic device of claim 26, wherein the at least one extension for packet-switched streaming service quality of experience metrics includes syntax for reporting a list of elements among the most recent list of active elements that have not been correctly received and decoded.

29. The electronic device of claim 26, wherein the at least one extension for packet-switched streaming service quality of experience metrics includes syntax for reporting which elements are correctly received, decoded and active in a current group of received rich media content.

30. The electronic device of claim 26, wherein the at least one extension for packet-switched streaming service quality of experience metrics includes syntax for reporting a Corruption Duration that is measured by a count of corrupted scene updates.

31. The electronic device of claim 26, wherein the at least one extension for packet-switched streaming service quality of experience metrics includes syntax for deducing a boundary between groups in a scene of received rich media content.

32. The electronic device of claim 23, wherein the at least one quality of service metric extension includes at least one extension in the extended real time transport protocol profile for RTCP-based feedback.

33. The electronic device of claim 32, wherein the at least one extension in the extended real time transport protocol profile for RTCP-based feedback includes an indication of a loss of packets for each priority during one specific period of received rich media content.

34. The electronic device of claim 32, wherein the at least one extension in the extended real time transport protocol profile for RTCP-based feedback includes an indication of how many elements which are among the most recent list of active elements have not been correctly received and decoded.

35. The electronic device of claim 32, wherein the at least one extension in the extended real time transport protocol profile for RTCP-based feedback includes an indication elements that have been correctly received, decoded and active in a current group of received data.

36. The electronic device of claim 32, wherein the at least one extension in the extended real time transport protocol profile for RTCP-based feedback includes an indication of corruption duration during one group of received data.

37. The electronic device of claim 32, wherein the at least one extension in the extended real time transport protocol profile for RTCP-based feedback includes an indication of corrupted groups due to the loss of packets of received scene data.

38. The electronic device of claim 23, wherein the rich media content comprises dynamic and interactive media scenes (DIMS)-specific content.

39. The electronic device of claim 38, wherein the at least one quality of service metric extension describes a number of Real-Time Transport Protocol (RTP) packets lost for each priority of the received rich media content during a specific period.

40. The electronic device of claim 38, wherein the at least one quality of service metric extension describes DIMS scenes received from the remote device which have been corrupted.

41. The electronic device of claim 38, wherein the at least one quality of service metric extension describes DIMS scene updates received from the remote device which have been corrupted.

42. The electronic device of claim 38, wherein the at least one quality of service metric extension describes both corrupted DIMS scenes and corrupted DIMS scene updates received from the remote device.

43. The electronic device of claim 38, wherein the at least one quality of service metric extension describes a duration of corrupted DIMS scenes and scene updates received from the remote device.
